(19) United States
(12) Patent Application Publication
(10) Pub. No.: US 2014/0137164 A1
(43) Pub. Date: May 15, 2014

(54) IN-FLIGHT ENTERTAINMENT SYSTEMS AND METHODS FOR PROVIDING DIGITAL CONTENT IN AN AERIAL VEHICLE

(71) Applicant: DELTA NETWORKS, INC., Taipei (TW)

(72) Inventors: Hsi-Ching YANG, Taipei (TW); Ta LIN, Taipei (TW); Chien-Heng WU, Taipei (TW); Jyh-Ming KUO, Taipei (TW); Tsen-Hsiao LIU, Taipei (TW)

(73) Assignee: DELTA NETWORKS, INC., Taipei (TW)

(21) Appl. No.: 13/678,154

(22) Filed: Nov. 15, 2012

(51) Int. Cl. H04N 21/214

(52) U.S. Cl. CPC H04N 21/2146
USPC 725/76

(57) ABSTRACT

An In-Flight Entertainment system is provided with a server unit and a display unit. The server unit is configured to maintain digital content. The display unit is configured to connect to the server unit through a wired network for receiving and presenting the digital content. The display unit further includes a wireless module for wirelessly transmitting the digital content received from the server unit to be presented by a first portable device.

### BACKGROUND OF THE INVENTION

1. Field of the Invention

The invention generally relates to the design of an In-Flight Entertainment system, and more particularly, to an incorporative In-Flight Entertainment system which provides both wired and wireless connectivity.

2. Description of the Related Art

Seat-back In-Flight Entertainment systems are adopted as the most common design for In-Flight Entertainment systems, in which the so-called Seat Video Display Unit (SVDU) are disposed on the back of cabin seats to receive digital content from a Content Server Unit (CSU) and present the digital content to passengers for viewing or listening pleasure. Disadvantageously, installation of the seat-back In-Flight Entertainment systems requires huge modifications of cabin seats and results in high costs. In addition, the weight of thousands of SVDUs increases fuel consumption for aerial vehicles.

To reduce the cost of seat-back In-Flight Entertainment systems, many aviation companies choose to decrease the number of SVDUs disposed on cabin seats by forcing a plurality of passengers to share one SVDU. However, this could severely affect user's service quality.

Thus, it is desirable to have an In-Flight Entertainment system which provides flexible system configurations for aviation companies with different budget and service class concerns, so that adequate service quality may be maintained while controlling costs.

### BRIEF SUMMARY OF THE INVENTION

To solve the aforementioned problems, the invention proposes an incorporative In-Flight Entertainment system which provides both wired and wireless connectivity and takes full advantage of the extensive use of portable devices worldwide, since almost everyone has at least one portable device in which the Men-Machine Interface (MMI) is usually flexible (e.g., touch control, and/or voice control, etc.) and user-friendly.

In one aspect of the invention, an In-Flight Entertainment system comprising a server unit and a display unit is provided. The server unit maintains digital content. The display unit is connected to the server unit via a wired network to receive and present the digital content, and comprises a wireless module for wirelessly transmitting the received digital content to be presented in a first portable device.

In another aspect of the invention, a method for providing digital content in an aerial vehicle is provided. The method comprises the steps of disposing, in the aerial vehicle, a wired network connecting a display unit and a server unit which maintains digital content; receiving, by the display unit, the digital content from the server unit via the wired network and presenting the digital content; and wirelessly transmitting, by a wireless module of the display unit, the received digital content to be presented in a first portable device.

Other aspects and features of the invention will become apparent to those with ordinary skill in the art upon review of the following descriptions of specific embodiments of In-Flight Entertainment systems and methods for providing digital content in an aerial vehicle.

### BRIEF DESCRIPTION OF DRAWINGS

The invention can be more fully understood by reading the subsequent detailed description and examples with references made to the accompanying drawings, wherein:

FIG. 1 is a block diagram illustrating an In-Flight Entertainment system according to an embodiment of the invention;

FIG. 2 is a flow chart illustrating the method for providing digital content in an aerial vehicle according to an embodiment of the invention;

FIG. 3 is a flow chart illustrating the method for providing digital content in the first service class cabin via a wired network according to the embodiment of FIG. 1;

FIG. 4 is a flow chart illustrating the method for providing digital content in the first service class cabin via a wireless network according to the embodiment of FIG. 1; and

FIG. 5 is a flow chart illustrating the method for providing digital content in the second service class cabin according to the embodiment of FIG. 1.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

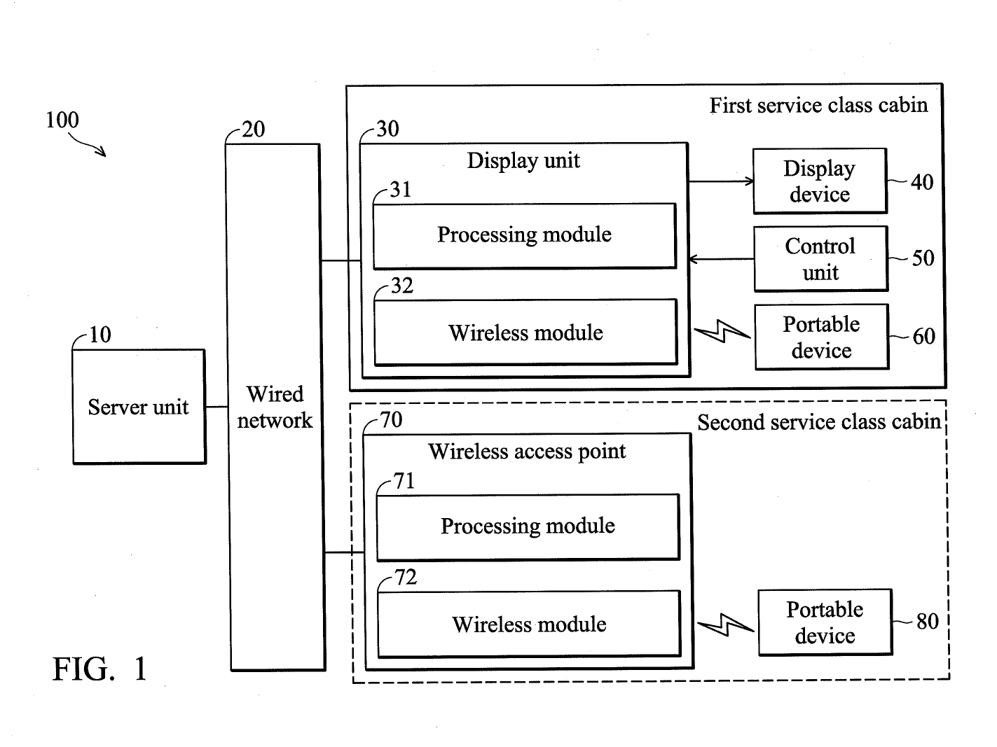

FIG. 1 is a block diagram illustrating an In-Flight Entertainment system according to an embodiment of the invention. In the In-Flight Entertainment system 100, the server unit 10 is responsible for maintaining digital content, such as video files of movies or TV programs, audio and music files, and program files of TV games, etc. Also, the server unit 10 connects to the wired network 20 for interfacing with other devices in the In-Flight Entertainment system 100. In one embodiment, the wired network 20 may be an ethernet network, and the server unit 10 may include a Network Interface Card (NIC) for providing Ethernet connections.

In this embodiment, the In-Flight Entertainment 100 is disposed in an aerial vehicle which comprises at least a first service class cabin (denoted in solid line). Alternatively, in other embodiments, the aerial vehicle may comprise multiple service class cabins. For example, the service class cabins are divided by service class into a first service class cabin (denoted in solid line), such as the First Class or Business Class cabin, and a second service class cabin (denoted in dotted line), such as the Economy Class cabin.

The display unit 30, the display device 40, and the control unit 50 are disposed in the first service class cabin. The display unit 30 is coupled to the display device 40 and the control unit 50, and connects to the server unit 10 via the wired network 20 for receiving and presenting the digital content. The display device 40 may be a screen, panel, touch panel, or any device with displaying functionality. The control unit 50 may be a microphone, a keyboard, buttons, a touch pad, or any combination thereof, for receiving user commands which instructs the display unit 30 to receive specific digital content from the server unit 10.

The display unit 30 comprises a processing module 31 and a wireless module 32. The processing module 31 may be a general purpose processor, an Application Processor (AP), or a Micro Control Unit (MCU) which is responsible for executing machine-readable instructions to present the digital content received from the server unit 10 and to control the operations of the wireless module 32 and the communications with the server unit 10, the display device 40, and the control unit 50. The wireless module 32 is responsible for providing wireless connectivity to the portable device 60 in the same service class cabin, using a specific wireless technology, such as the Wireless Fidelity (WiFi) technology, the Bluetooth (BT) technology, the Zigbee technology, or the Z-Wave technology. The portable device 60 may receive the digital content from the server unit 10 via the wireless module 32, and on the other hand, may connect to the Internet via the wireless module 32 for Internet-related applications, such as web browsing, email transmitting/receiving, etc. The portable device 60 may be a smart phone, panel Personal Computer (PC), laptop computer, or any multimedia device with networking functionality, and it supports the same wireless technology as utilized by the wireless module 32.

It is noted that, in the present invention, wireless connectivity may be provided by the wireless module 32 incorporated in the display unit 30, and no extra work is required for disposing a wireless network in the first service class cabin.

To further clarify, the wireless module 32 may contain a Baseband module (not shown), a Radio Frequency (RF) module (not shown), and an antenna (not shown). The Baseband module may contain multiple hardware devices to perform baseband signal processing, including analog to digital conversion (ADC)/digital to analog conversion (DAC), gain adjusting, modulation/demodulation, encoding/decoding, and so on. The RF module may receive RF wireless signals via the antenna, convert the received RF wireless signals to baseband signals, which are processed by the baseband module, or receive baseband signals from the baseband module and convert the received baseband signals to RF wireless signals, which are later transmitted via the antenna.

In one embodiment, the display unit 30, the display device 40, and the control unit 50 may be disposed on all or some seats in the first service class cabin. Or optionally, in another embodiment, the display unit 30 may be disposed on only one seat in a certain seat area, while the rest of the seats in the seat area are each disposed with a display unit without a wireless module incorporated therein. For example, the display unit 30 may be disposed on one seat in every three rows of seats, and the rest of the seats in the three rows are each disposed with a display unit without a wireless module. Thus, all portable devices located in the seat area may obtain wireless connectivity from the wireless module 32 in the display unit 30.

In another embodiment, the display unit 30 may further contain a storage unit (not shown) for storing portions of the digital content maintained in the server unit 10 or storing the digital content preloaded from the server unit 10, so that the display unit 30 and the portable device 60 may continue to play the digital content, in case of disconnection with the wired network 20.

Alternatively, in the second service class cabin, a wireless access point 70 may be disposed for providing wireless connectivity to the portable device 80 in the same service class cabin. The wireless access point 70 may comprise a processing module 71 and a wireless module 72. The processing module 71 may be a general purpose processor, an AP, or an MCU which is responsible for executing machine-readable instructions to receive the digital content from the server unit 10 and to control the operations of the wireless module 72. Detailed description of the wireless module 72 is similar to that of the wireless module 32, and is not repeated here for brevity.

In another embodiment, the wireless access point 70 may further contain a storage unit (not shown) for storing portions of the digital content maintained in the server unit 10 or storing the digital content preloaded from the server unit 10, so that the portable device 80 may continue to play the digital content, in case of disconnection with the wired network 20.

In the present invention, it is expected that the bandwidth of the wired network 20 is more stable while the bandwidth of the wireless network (formed by the wireless module 32 or the wireless access point 70) is less stable due to possible interference to the transceiving of wireless signals. In other words, it may be assumed that the wired network 20 is suitable for delivering the high-resolution media streaming services and datacom services, and the wireless network is suitable for low-resolution media streaming services and datacom services. In the embodiment of FIG. 1, since different system configurations may be applied for different service class cabins, the server unit 10 may determine different Quality of Service (QoS) for the digital content to be sent to the display unit 30 and the wireless access point 70 according to the located service class cabin. For example, the digital content to be sent to the display unit 30 may be assigned with a high QoS, and the digital content to be sent to the wireless access point 70 may be assigned with a low QoS.

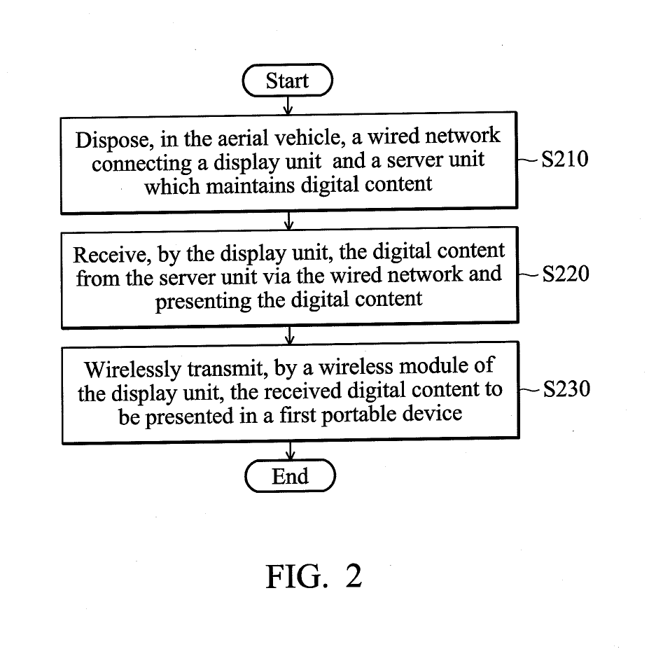

FIG. 2 is a flow chart illustrating the method for providing digital content in an aerial vehicle according to an embodiment of the invention. To begin, in an aerial vehicle, a wired network connecting a display unit and a server unit which maintains digital content is disposed (step S210). Next, the digital content is received and presented, by the display unit, from the server unit via the wired network (step S220). After that, the received digital content is wirelessly transmitted, by a wireless module of the display unit, to be presented in a first portable device (step S230).

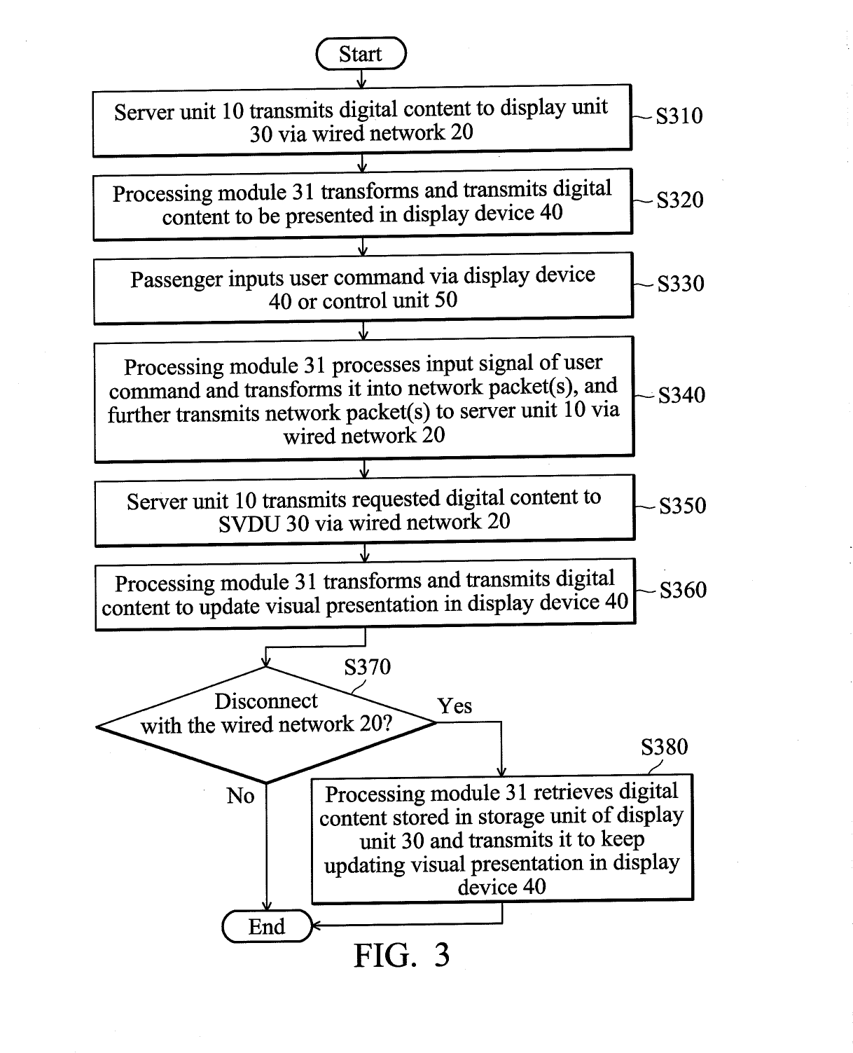

FIG. 3 is a flow chart illustrating the method for providing digital content in the first service class cabin via a wired network according to the embodiment of FIG. 1. To begin, the server unit 10 transmits the digital content to the display unit 30 via the wired network 20 (step S310). After processing the received digital content, the processing module 31 transforms and transmits the digital content to be presented in the display device 40 (step 320).

Next, the passenger views the visual presentation provided by the display device 40 and then inputs a user command via the display device 40 or the control unit 50 (step S330). In the display unit 30, the processing module 31 processes the input signal of the user command and transforms it into network packet(s), and further transmits the network packet(s) to the server unit 10 via the wired network 20 (step S340).

Subsequently, the server unit 10 transmits the digital content requested by the user command to the display unit 30 via the wired network 20 (step S350). After processing the received digital content, the processing module 31 transforms and transmits the digital content to update the visual presentation in the display device 40 (step 360).

After that, the display unit 30 detects whether a disconnection with the wired network 20 has occurred during the visual presentation in the display device 40 (step S370). If so, the processing module 31 retrieves the digital content stored in the storage unit (not shown) of the display unit 30 and transmits it to keep updating the visual presentation in the display device 40 (step 380), so that the media streaming service or datacom service may be provided to the passengers in the first service class cabin without service break-off.

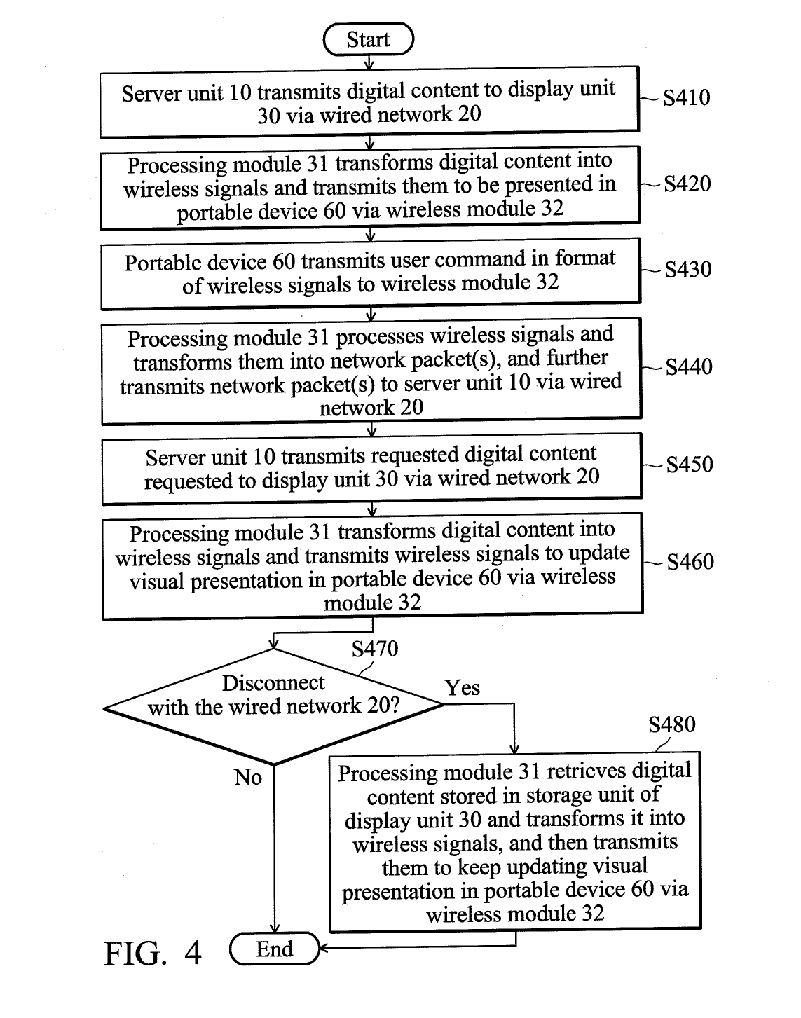

FIG. 4 is a flow chart illustrating the method for providing digital content in the first service class cabin via a wireless network according to the embodiment of FIG. 1. To begin, the server unit 10 transmits the digital content to the display unit 30 via the wired network 20 (step S410). After processing the received digital content, the processing module 31 transforms the digital content into wireless signals and transmits them to be presented in the portable device 60 via the wireless module 32 (step 420).

Next, the passenger views the visual presentation provided by the portable device 60 and then inputs a user command which is later transmitted to the wireless module 32 in the format of wireless signals (step S430). In the display unit 30, the processing module 31 processes the wireless signals and transforms them into network packet(s), and further transmits the network packet(s) to the server unit 10 via the wired network 20 (step S440).

Subsequently, the server unit 10 transmits the digital content requested by the user command to the display unit 30 via the wired network 20 (step S450). After processing the received digital content, the processing module 31 transforms the digital content into wireless signals and transmits the wireless signals to update the visual presentation in the portable device 60 via the wireless module 32 (step 460).

After that, similar to the steps 370 and S380, the display unit 30 detects whether a disconnection with the wired network 20 has occurred during the visual presentation in the portable device 60 (step S470). If so, the processing module 31 retrieves the digital content stored in the storage unit (not shown) of the display unit 30 and transforms it into wireless signals, and then transmits them to keep updating the visual presentation in the portable device 60 via the wireless module 32 (step 480). Thus, the media streaming service or datacom service may be provided to the passengers in the first service class cabin without service break-off.

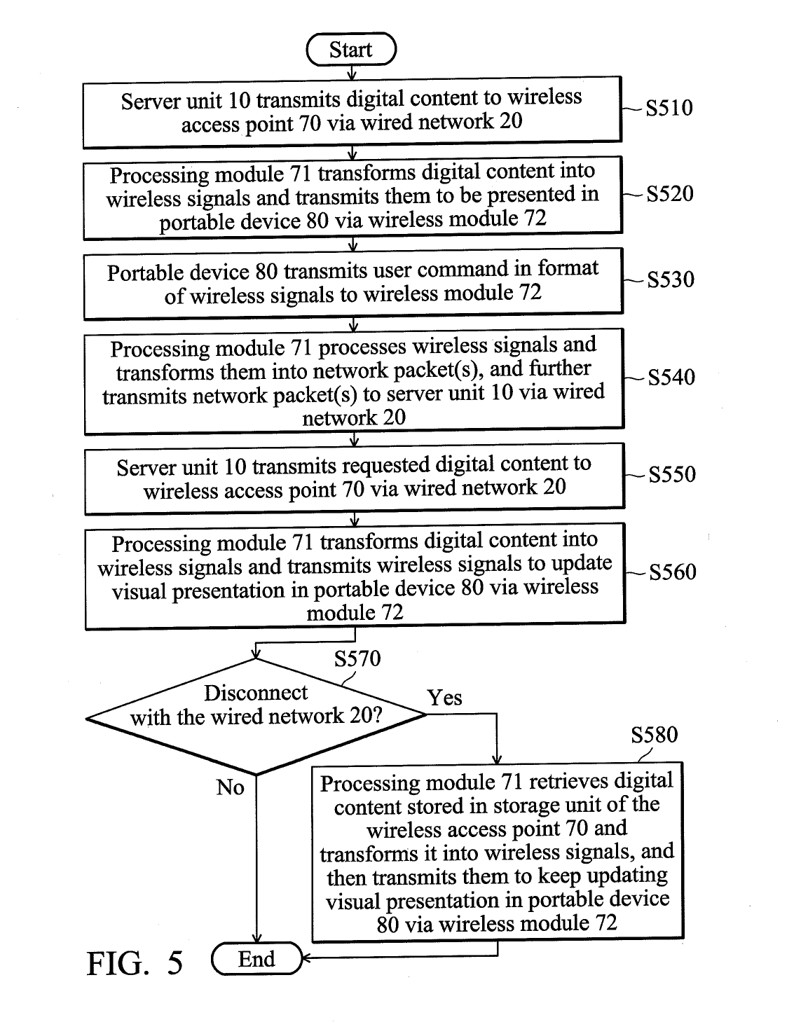

FIG. 5 is a flow chart illustrating the method for providing digital content in the second service class cabin according to the embodiment of FIG. 1. Similar to FIG. 4, the server unit 10 first transmits the digital content to the wireless access point 70 via the wired network 20 (step S510). After processing the received digital content, the processing module 71 transforms the digital content into wireless signals and transmits them to be presented in the portable device 80 via the wireless module 72 (step 520).

Next, the passenger views the visual presentation provided by the portable device 80 and then inputs a user command which is later transmitted to the wireless module 72 in the format of wireless signals (step S530). In the wireless access point 70, the processing module 71 processes the wireless signals and transforms them into network packet(s), and further transmits the network packet(s) to the server unit 10 via the wired network 20 (step S540).

Subsequently, the server unit 10 transmits the digital content requested by the user command to the wireless access point 70 via the wired network 20 (step S550). After processing the received digital content, the processing module 71 transforms the digital content into wireless signals and transmits the wireless signals to update the visual presentation in the portable device 80 via the wireless module 72 (step 560).

After that, the wireless access point 70 detects whether a disconnection with the wired network 20 has occurred during the visual presentation in the portable device 80 (step S570). If so, the processing module 71 retrieves the digital content stored in the storage unit (not shown) of the wireless access point 70 and transforms it into wireless signals, and then transmits them to keep updating the visual presentation in the portable device 80 via the wireless module 72 (step 580). Thus, the media streaming service or datacom service may be provided to the passengers in the second service class cabin without service break-off.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the invention shall be defined and protected by the following claims and their equivalents. Note that use of ordinal terms such as “first”, “second”, “third”, etc., in the claims to modify a claim element does not by itself connote any priority, precedence, or order of one claim element over another or the temporal order in which acts of the method are performed, but are used merely as labels to distinguish one claim element, having a certain name, from another element, having a same name (except for use of ordinal terms), to distinguish the claim elements.

1. An In-Flight Entertainment system, comprising:
a server unit, maintaining digital content, and providing a first Quality of Service (QoS) of the digital content and a second QoS of the digital content, wherein the first QoS is higher than the second QoS;
a display unit, connected to the server unit to receive and present the digital content with the first QoS;
a wireless access point, wirelessly transmitting the received digital content with the second QoS to be presented in a first portable device; and
a wired network, interconnecting the server unit, the display unit, and the wireless access point,
wherein the display unit receives the digital content with the first QoS via the wired network and the first portable device receives the digital content with the second QoS via the wireless access point.

2. (canceled)

3. The In-Flight Entertainment system of claim 1, wherein the display unit is located in a first class service cabin and the first portable device is located in a second class service cabin.

4. (canceled)

5. The In-Flight Entertainment system of claim 1, wherein the display unit further comprises a storage unit for storing portions of the digital content with the first QoS, so that the presentation of the digital content by the display unit continues when a disconnection with the wired network occurs.

6. The In-Flight Entertainment system of claim 1, wherein the wireless access point further comprises a storage unit for storing portions of the digital content, so that the presentation of the digital content in the second first portable device continues when a disconnection with the wired network is occurred occurs.

7. The In-Flight Entertainment system of claim 1, wherein the display unit is coupled to a display device for presenting the received digital content with the first QoS, and is coupled to a control device for receiving a user command, wherein the reception of the digital content with the first QoS from the server unit is performed in response to the user command.

8. The In-Flight Entertainment system of claim 1, wherein the wired network is an ethernet network.

9. The In-Flight Entertainment system of claim 1, wherein the wireless transmission of the digital content is performed using WiFi technology, Bluetooth technology, Zigbee technology, or Z-Wave technology.

10. (canceled)

11. (canceled)

12. (canceled)

13. (canceled)

14. (canceled)

15. (canceled)

16. (canceled)

17. (canceled)

18. (canceled)

19. An In-Flight Entertainment system, comprising:
a server unit, maintaining digital content, and providing a first Quality of Service (QoS) and a second QoS of the digital content, wherein the first QoS is higher than the second QoS;
a display unit, disposed in a first class service cabin, connected to the server unit to receive and present the digital content with the first QoS;
a wireless access point, disposed in a second class service cabin, wirelessly transmitting the received digital content with the second QoS to be presented in a first portable device; and a wired network, interconnecting the server unit, the display unit, and the wireless access point,
wherein the server unit determines the first QoS and the second QoS of the digital content to be sent to the display unit and the wireless access point, respectively, according to their located class service cabins, and the display unit receives the digital content with the first QoS via the wired network and the first portable device receives the digital content with the second QoS via the wireless access point.
